(19) United States
(12) Patent Application Publication
(10) Pub. No.: US 2026/0039142 A1
(43) Pub. Date: Feb. 5, 2026

(54) ELECTRICAL POWER SOURCE SIGNALING AND COMMUNICATION NETWORK CONFIGURATION

(71) Applicant: AT&T Intellectual Property I, L.P., Atlanta, GA (US)

(72) Inventor: Dan Druta, Sammamish, WA (US)

(21) Appl. No.: 18/792,496

(22) Filed: Aug. 1, 2024

(51) Int. Cl. H02J 13/00

(52) U.S. Cl. CPC H02J 13/0001; H02J 13/00002

(57) ABSTRACT

A processing system including at least one processor deployed in a communication network may obtain an alternating current electrical power signal via an electrical power distribution line, where the alternating current electrical power signal is modulated to include electrical power source information for a source of electrical power. The processing system may next extract the electrical power source information from the alternating current electrical power signal. The processing system may then provide the electrical power source information to at least one element of the communication network to perform at least one control action in the communication network in response to the electrical power source information.

The present disclosure relates generally to communication network operations, and more particularly to methods, computer-readable media, and apparatuses for extracting electrical power source information from an alternating current electrical power signal and providing the electrical power source information to at least one communication network element, and to methods, computer-readable media, and apparatuses for selecting at least one control action for a communication network in response to electrical power source information obtained via an alternating current electrical power distribution line.

### BACKGROUND

Upgrading a communication network to a software defined network (SDN) architecture implies replacing or augmenting existing network elements that may be integrated to perform a single function with new network elements. The replacement technology may comprise a substrate of networking capability, often called network function virtualization infrastructure (NFVI) that is capable of being directed with software and SDN protocols to perform a broad variety of network functions and services. Different locations in the communication network may be provisioned with appropriate amounts of network substrate, and to the extent possible, routers, switches, edge caches, middle-boxes, and the like, may be instantiated from the common resource pool.

### SUMMARY

The present disclosure describes methods, computer-readable media, and apparatuses for extracting electrical power source information from an alternating current electrical power signal and providing the electrical power source information to at least one communication network element. For instance, in one example, a processing system including at least one processor deployed in a communication network may obtain an alternating current electrical power signal via an electrical power distribution line, where the alternating current electrical power signal is modulated to include electrical power source information for a source of electrical power. The processing system may next extract the electrical power source information from the alternating current electrical power signal. The processing system may then provide the electrical power source information to at least one element of the communication network to perform at least one control action in the communication network in response to the electrical power source information.

The present disclosure also describes methods, computer-readable media, and apparatuses for selecting at least one control action for a communication network in response to electrical power source information obtained via an alternating current electrical power distribution line. For instance, in one example, a processing system including at least one processor may obtain electrical power source information for a source of electrical power to at least one network element of a communication network, wherein the electrical power source information is obtained via an alternating current electrical power distribution line. The processing system may next select at least one control action for a communication network in response to the electrical power source information. The processing system may then perform the at least one control action in the communication network.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for extracting electrical power source information from an alternating current electrical power signal and providing the electrical power source information to at least one communication network element;

FIG. 3 illustrates a flowchart of an example method for selecting at least one control action for a communication network in response to electrical power source information obtained via an alternating current electrical power distribution line; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for extracting electrical power source information from an alternating current electrical power signal and providing the electrical power source information to at least one communication network element. Examples of the present disclosure further describe methods, computer-readable media, and apparatuses for selecting at least one control action for a communication network in response to electrical power source information obtained via an alternating current electrical power distribution line.

To illustrate, the Internet has accelerated the use of mobile networks and facilitated the digital transformation for many fields. While data networks have evolved and capacity has generally increased, many aspects have remained relatively unchanged over the course of years. Examples of the present disclosure associate non-Internet Protocol (IP) information, e.g., metadata, with network elements and traffic flows to be analyzed, aggregated, and processed in real-time or on demand. In particular, in one example, such metadata may comprise energy utilization information in accordance with the present disclosure, which may be used to calculate network utilization energy consumption for a network element, entity, or system, to request and/or implement energy utilization-aware routing, to provision software-defined network (SDN) resources, and so forth.

In one example, a network element may obtain electrical power source information from an alternating current electrical power signal via an electrical power distribution line. For instance, the electrical power source information may include an identification of a source of electrical power for the network element and/or a type of the source of electrical power, e.g., solar, wind, hydroelectric, geothermal, coal, natural gas, nuclear, etc. In accordance with the present disclosure, the alternating current electrical power signal may be modulated to include the electrical power source information for the source of electrical power. In one example, a network element may then extract the electrical power source information from the alternating current electrical power signal. For instance, in one example, a power supply module may include a demodulator, or modem, to extract the electrical power source information from the alternating current electrical power signal. The power supply module may then provide the electrical power source information to at least one element of the communication network to perform at least one control action in the communication network in response to the electrical power source information.

In one example, the electrical power source information may include an authenticity and integrity protection mechanism. For instance, while the electrical power source information may be modulated at a relatively low data rate, the content may be encrypted such that the signaling is meaningful upon demodulation and decryption by a power supply module in possession of an appropriate key to decrypt the electrical power source information. In one example, encryption/decryption keys may be passed via a separate path, such as application-level internet-based communications between a power supplier computing system and that of a network operator, where the key may be passed to the power supply module. In addition, the network operator computing system may engage in any number of authentication query/response exchanges to confirm that it is in fact communicating with the a power supplier computing system.

To further illustrate, in one example, the power supply module may provide the electrical power source information to a network element of which the power supply module is a part. Alternatively, or in addition, the electrical power source information may be provided to a different network element, e.g., by the network element of which the power supply module is a part of, and/or by the power supply module directly. For example, the network element may comprise a router, which may report the electrical power source information to one or more other routers, to one or more endpoint devices, to a software-defined network (SDN) controller and/or self-optimizing network (SON) orchestrator, and so forth. The network element(s) may then perform at least one control action in the communication network in response to the electrical power source information. For instance, in one example, an SDN controller may instantiate, de-instantiate, and/or configure a virtual network function (VNF) based on the electrical power source information of one or more network elements. In another example, a router may make a routing decision and may forward packets along a path selected based upon the electrical power source information of one or more network elements, e.g., one or more routers. For instance, an energy source-aware router may choose a next hop router that may have a solar energy source versus a different router that may have a coal-powered plant as the energy source.

To further illustrate, in one example, the present disclosure may include a secure control channel that is established and enabled in parallel to a user plane data network (e.g., an “out-of-band” control channel) for passing metadata (e.g., energy utilization data, and other data) between network nodes. In one example, the control channel may use a publish/subscribe model, a broadcasting model, or the like. Examples of the present disclosure provide a secure, open, and flexible mechanism for applications and network infrastructure to establish an event-driven fabric or control channel where network node related metadata or other parameters can be shared. In addition, such an application level control channel may be extended to additional uses, including automatic multi-factor authentication where tokens can be sent using the secure, trusted network. In addition, the exposure of network node parameters via a secure control channel of the present disclosure may further eliminate the need for application programming interface (API) gateways or the like.

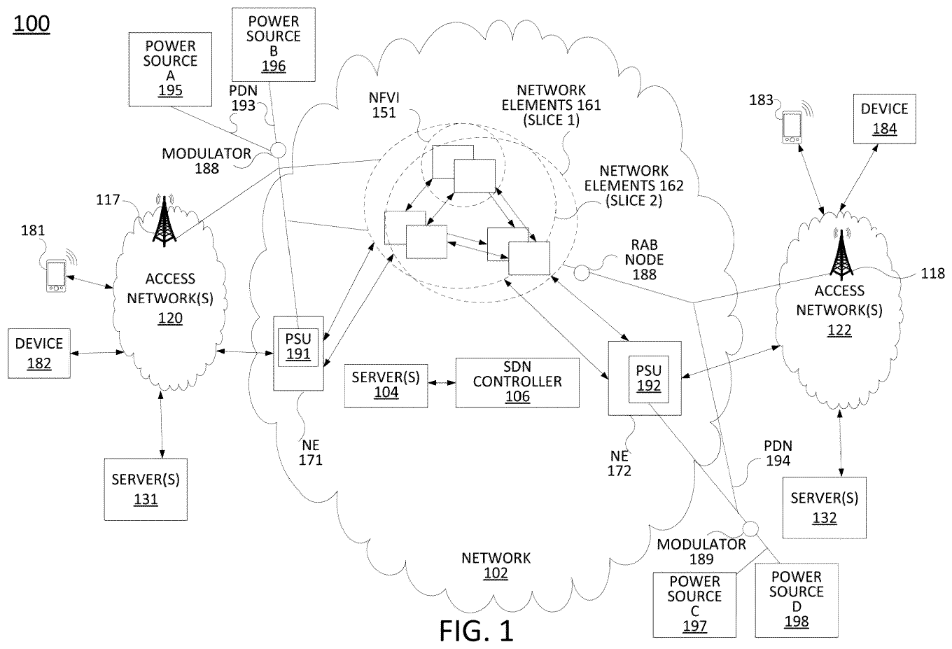

In one example, the present disclosure may implement a control channel via network slicing or other isolation techniques. For instance, the control channel may comprise a low-bandwidth, latency-sensitive virtual network that may enable authorized participants (e.g., network nodes) to join. In one example, participants may subscribe to specific messaging channels of interest, such as energy metadata or authentication tokens. To illustrate, participants in a control channel virtual network may be on-boarded using public key infrastructure (PKI). In addition, based on flexible access control mechanism(s), participants may subscribe to authorized sub-channels, effectively creating a secure, open control channel via a trusted, flexible virtual network for metadata exchange/distribution. It is again noted that examples of the present disclosure enable the exchange of non-network traffic-related metadata that may augment the ability to perform packet/flow handling decisions (e.g., routing) in addition to supporting the calculation of complex performance indicators, such as network-based energy utilization per flow, per application, or the like, energy efficiency per node, quantities and/or percentages of energy utilization per energy source and/or per type of energy source (e.g., natural gas, coal, nuclear, wind, solar, geothermal, hydroelectric, etc.), and so forth. These and other aspects of the present disclosure are discussed in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G, 6G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a core network, and one or more access networks 120 and 122, and the Internet (not shown). In one example, network 102 may combine core network components of a cellular network with components of a triple play service network; where triple-play services include telephone services, Internet services and video services (e.g., television services) to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. Network 102 may further comprise a video broadcast network, e.g., a traditional cable provider network or an Internet Protocol Television (IPTV) network, as well as an Internet Service Provider (ISP) network. In one example network 102 may include multiple “network slices,” e.g., slices 1 and 2 comprising network elements 161 and 162, respectively. Slices 1-2 may include hardware components, which may comprise physical network elements, or virtual network elements on shared hardware (e.g., virtual network elements, or network functions), and capacity allocations (e.g., bandwidth on a link, etc.). It should be noted that a “slice” may be further characterized by service level and security targets, e.g., minimum throughput, uptime, priority, etc. In one example, network 102 may include one or more servers 104, a software defined network (SDN) controller 106, and network elements (NEs) 171 and 172, as discussed in further detail below. In one example, network 102 may also include a plurality of video servers (e.g., a broadcast server, a cable head-end), a plurality of content servers, an advertising server, and so forth. For ease of illustration, various additional elements of network 102 are omitted from FIG. 1.

In one example, the access networks 120 and 122 may comprise fiber optic access networks (e.g., fiber to the curb (FTTC) and/or fiber to the premises (FTTP) access networks), Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of network 102 may provide data services, voice/telephony services, cable television services, an IPTV service, a streaming service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a communication network service provider. The network 102 and the access networks 120 and 122 may be operated by different service providers, the same service provider or a combination thereof, or may be operated by entities having core businesses that are not related to communication services, e.g., corporate, governmental or educational institution LANs, and the like. In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with various endpoint devices. For instance, as illustrated in FIG. 1, access network(s) 120 may include at least wireless access point 117 (e.g., a cellular base station). Similarly, access network(s) 122 may include at least wireless access point 118 (e.g., a cellular base station).

In one example, the access network(s) 120 may be in communication with various devices, local networks, and/or computing systems/processing systems. For instance, the access network(s) 120 may be in communication with devices 181 and 182, and server(s) 131. Similarly, the access network(s) 122 may be in communication with devices 183 and 184, and server(s) 132. Devices 181-184 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of devices 181-184 may represent one or more user/subscriber devices (e.g., user equipment (UE)/user endpoint devices). In one example, any one or more of devices 181-184 may be equipped with wired and/or wireless networking/communication capability. In this regard, any one or more of devices 181-184 may include transceivers for wireless communications, e.g., for Institute for Electrical and Electronics Engineers (IEEE) 802.11 based communications (e.g., “Wi-Fi”), IEEE 802.15 based communications (e.g., “Bluetooth,” “ZigBee,” etc.), cellular communication (e.g., 3G, 4G/LTE, 5G, 6G, etc.), and so forth. In addition, server(s) 131 and 132 may represent one or more computing devices/processing systems comprising web servers, content servers and/content distribution network (CDN) nodes, database servers, and so forth.

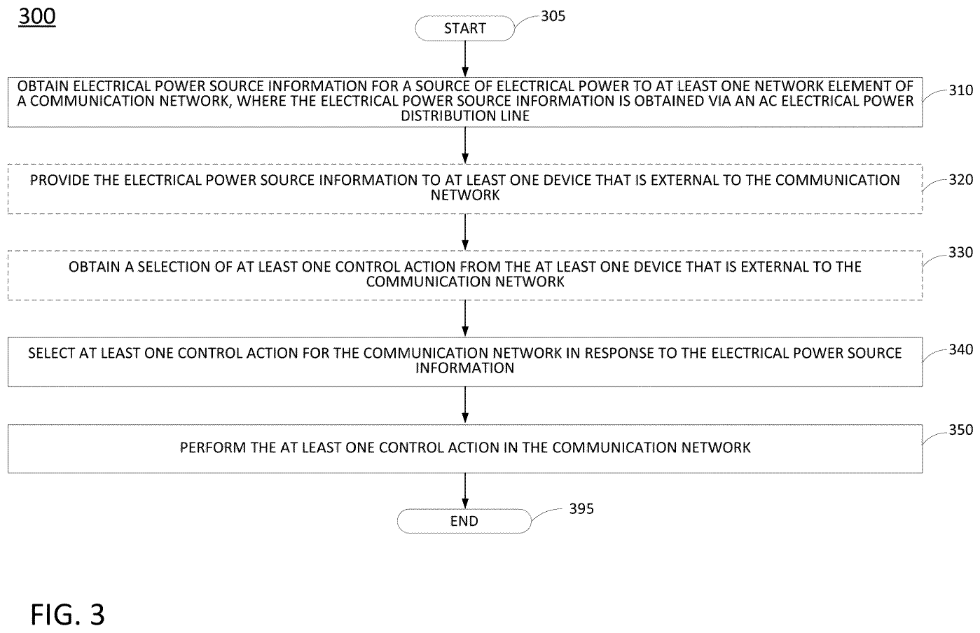

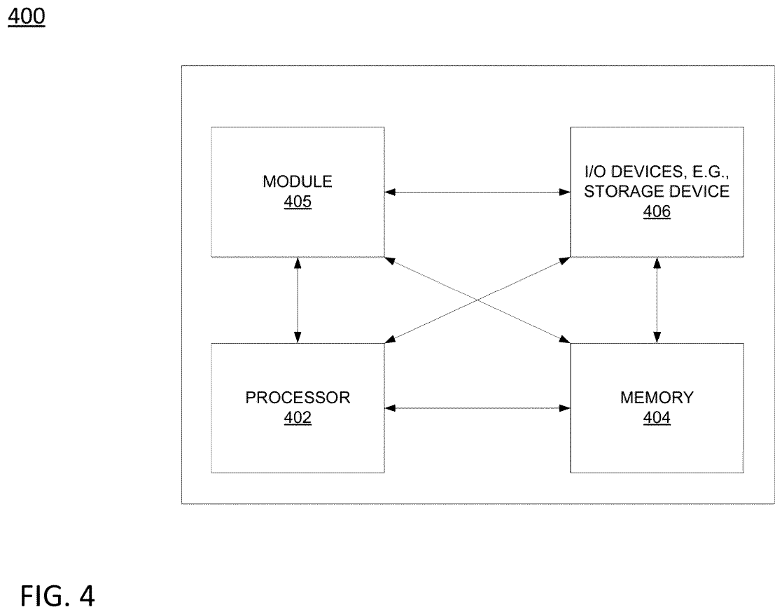

In accordance with the present disclosure, server(s) 104 may comprise a computing system or server, or one or more computing systems or servers, such as computing system 400 depicted in FIG. 4, and may individually or collectively be configured to perform operations or functions for selecting at least one control action for a communication network in response to electrical power source information obtained via an alternating current electrical power distribution line (such as illustrated and described in connection with the example method 300 of FIG. 3). Similarly, SDN controller 106 may comprise one or more computing systems or servers, such as computing system 400 depicted in FIG. 4, and may individually or collectively be configured to perform operations or functions for selecting at least one control action for a communication network in response to electrical power source information obtained via an alternating current electrical power distribution line (such as illustrated and described in connection with the example method 300 of FIG. 3).

It should also be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the network 102 may comprise network function virtualization infrastructure (NFVI), e.g., servers in a data center or data centers that are available as host devices to host virtual machines (VMs) and/or containers comprising virtual network functions (VNFs). In other words, at least a portion of the network 102 may incorporate software-defined network (SDN) components. In this regard, NFVI 151 is labeled in FIG. 1, and may comprise a node that hosts network elements (e.g., virtual network functions) from both slice 1 and slice 2 (e.g., at least one of network elements 161 and at least one of network elements 162). It should be understood that various others of network elements 161 and network elements 162 may be hosted on other NFVI of network 102. It should also be noted that in accordance with the present disclosure, the term “virtual network function” (or “VNF”), may refer to both virtual machine (VM)-based VNFs, e.g., VNFs deployed as VMs, and containerized or container-based (VNFs), e.g., VNFs deployed as containers, such as within a Kubernetes infrastructure, or the like, also referred to as “cloud-native network functions” (CNFs). To further illustrate, in one example, network elements 161-162 may comprise NFVI, e.g., in accordance with an SDN architecture of network 102, which may be configured to perform the functions of routers, switches, and other devices. For instance, network elements 161-162 may represent virtual provider edge (VPE) routers, virtual mobility management entities (vMMEs), virtual serving gateways (vSGWs), virtual packet data network gateways (vPDNGWs or VPGWs), or other virtual network functions (VNFs). It should be noted that in other, further, and different examples, network elements 161-162 may alternately or additionally comprise physical devices (e.g., dedicated devices) that may include routers, switches, firewalls, gateways, and so forth.

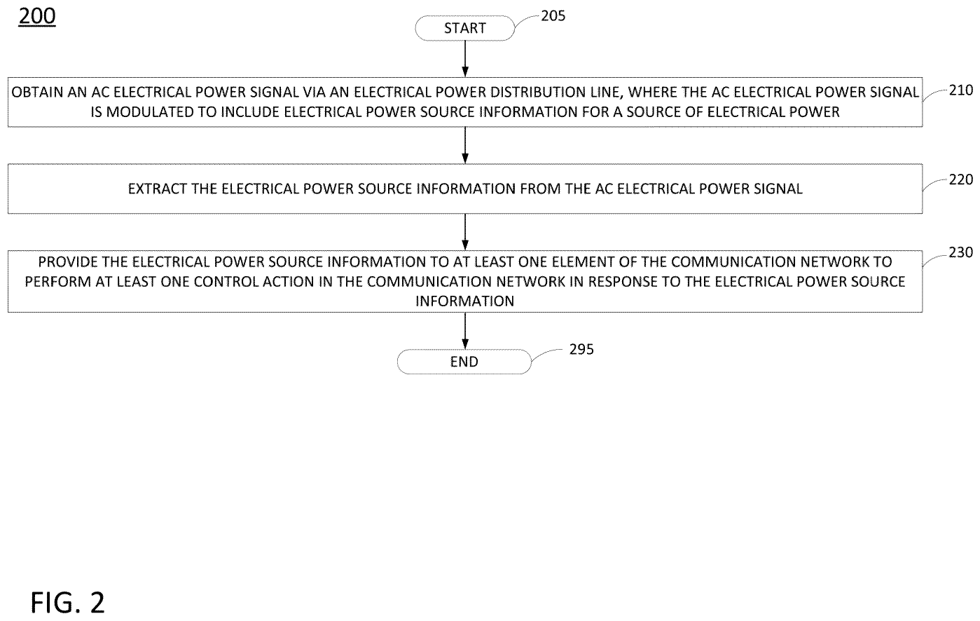

Similarly, in one example, network elements 171 and 172 may comprise gateways, routers, switches, serving gateways (SGWs), mobility management entity (MMEs), packet data network gateways (PGWs or PDNGWs), network slice selection functions (NSSFs), or the like. In one example, network elements 171 and 172 may comprise provider edge (PE) routers interfacing with access network(s) 120 and 122, e.g., for non-cellular network-based communications. In one example, network elements 171 and 172 may also comprise VNFs hosted by and operating on additional NFVI. However, in another example, either or both of network elements 171 and 172 may comprise dedicated devices or components. In one example, network elements 161, 162, 171, and/or 172 may be controlled and managed by the SDN controller 106. For instance, in one example, SDN controller 106 is responsible for such functions as provisioning and releasing instantiations of VNFs to perform the functions of routers, switches, and other devices, initializing routing tables and other operating parameters for the VNFs, and so forth. In one example, SDN controller 106 may maintain communications with VNFs and/or host devices/NFVI via a number of control links which may comprise secure tunnels for signaling communications over an underling IP infrastructure of network 102. In other words, the control links may comprise virtual links multiplexed with transmission traffic and other data traversing network 102 and carried over a shared set of physical links. In accordance with the present disclosure, each of network elements 161, 162, 171, and/or 172 and/or NFVI 151 may comprise a computing system or server, or one or more computing systems or servers, such as computing system 400 depicted in FIG. 4, and may individually or collectively be configured to perform operations or functions for extracting electrical power source information from an alternating current electrical power signal and providing the electrical power source information to at least one communication network element and/or for selecting at least one control action for a communication network in response to electrical power source information obtained via an alternating current electrical power distribution line (such as illustrated and described in connection with the example method 200 of FIG. 2 and/or the example method 300 of FIG. 3).

To further illustrate, the system 100 may include one or more electrical power distribution networks, e.g., an electric power grid, or power grids, such as power distribution network (PDN 193) and PDN 194. As referred to herein, an electrical power distribution network may comprise one or more electrical power distribution lines (e.g., power lines). Each of the PDNs may be connected to one or more power sources, such as power source A (195), power source B (196), power source C (197), and power source D (198). In this regard, it should be noted that some PDNs may have more than one power source that may provide electrical power to the respective PDN. For instance, at any given time, PDN 193 may distribute electrical power from power source A (195), power source B (196), or both. Similarly, PDN 194 may distribute electrical power from power source C (197), power source D (198), or both. As noted above, the different power sources may include solar, wind, hydroelectric, geothermal, coal, natural gas, nuclear, and so forth. It should be noted that although power source A (195), power source B (196), power source C (197), and power source D (198) are illustrated as distinct entities, it should be understood that a power source may comprise multiple power-producing component devices, systems, etc. For instance, power source A (195) may comprise a solar power source that includes a number of solar panels, e.g., a solar panel array, or numerous solar panel arrays that provide electrical power to the PDN 193. Similarly, power source C (197) may comprise a wind power source that includes a number of wind turbines, and so forth.

As illustrated in FIG. 1, PDN 193 may provide electric power (e.g., an alternating current (AC) electric power signal) to various network components, such as NE 171, network elements 161 and/or network elements 162, wireless access point 117, and so forth. Similarly, PDN 194 may provide electric power (e.g., an AC electric power signal) to various network components, such as NE 172, network elements 161 and/or network elements 162, wireless access point 118, and so forth. In accordance with the present disclosure, PDNs may transmit electrical power source information for a source of electrical power via AC electrical power signals. For instance, an AC electrical power signal may be modulated to include electrical power source information for a source of electrical power. To further illustrate, the AC electrical power signal may be modulated to include electrical power source information using power line communication (PLC), e.g., power line carrier communication (PLCC), broadband over power line (BPL), or the like. For example, these types of communication signals may use amplitude modulation (AM) on one or more carrier frequencies to convey digital data. For instance, higher frequency carriers (e.g., 500 Hz, 100 KHz, 200 KHz, or the like) may be used for PLC over AC electrical power signals, e.g., at 60 Hz or the like.

In one example, the electrical power source information may identify a source of the AC electrical power signal (e.g., nuclear reactor X, wind farm Y, solar array Z, etc.) and/or a type of a source of the AC electrical power signal (e.g., solar, wind, hydroelectric, geothermal, coal, natural gas, nuclear, etc.). In one example, the electrical power source information may also include optional information, such as: cost, geographic location of the source, cost information (e.g., cost per kilowatt hour, or the like), and so forth. Alternatively, or in addition, in one example, the electrical power source information may include percentages of electrical power from a plurality of sources to an electrical power distribution network. For instance, an electricity supplier may add electrical power to a power grid/PDN from multiple sources, where it may not be possible or may be challenging to segregate which end consumers of electrical power are receiving electrical power from which source. As such, the electrical power source information may include the types of sources and percentages of a total electrical power delivered to the power grid from the respective sources.

In one example, the electrical power source information may be added via a modulator, or transmitter, such as one of the modulators 188 or 189. For instance, these may inject the higher frequency carrier signals for electrical power source information onto the AC electrical power signal. In one example, the modulators 188 and 189 may be operated by respective electric power suppliers, e.g., associated with PDN 193 and PDN 194, respectively. It should be understood that additional components may be part of the modulators 188 and 189, or may be used in conjunction with the modulators 188 and 189, such as coupling capacitors, low frequency rejecting/blocking filters, high frequency rejecting/blocking filters, repeaters, and so forth.

In addition, in one example, various network components may include power supply modules, or power supply units (PSUs), e.g., “smart” PSUs. For instance, NE 171 may include PSU 191. Similarly, NE 172 may include PSU 192. For ease of illustration, various other network components/elements may include similar power supply modules, such as NFVI 151, and wireless access point 117 and/or wireless access point 118, and so on. To further illustrate, PSU 191 may include a demodulator to extract the electrical power source information from the AC electrical power signal, e.g., from PDN 193. In one example, the demodulator may comprise a modem for two-way communication over the PDN 193 (e.g., using a PLC/PLCC protocol/technology). PSU 192 may be similarly configured and may have the same or similar components, e.g., a demodulator and/or modem, etc. (and so forth for other network elements having power supplies for converting AC electrical power signals into direct current (DC) electrical currents to power the various components).

In one example, PSU 191 may be configured to provide the electrical power source information to at least one network element. For instance, this may include the host device in which the PSU 191 is installed and/or with which the PSU 191 is associated (e.g., the PSU 191 may be coupled to the NE 171, but may be external to a chassis, blade, rack, etc. that may house the other components of NE 171). Likewise, in one example, a PSU, such as PSU 191 may be shared among a plurality of network elements, e.g., two or more blades in a rack, etc. In an example in which the PSU 191 provides the electrical power source information to the host device (e.g., NE 171), the electrical power source information may be forwarded to the host device via an inter-integrated circuit (I2C) communication, a system management bus communication, a serial peripheral interface (SPI) communication, a controller area network communication, or the like. Alternatively, or in addition, PSU 191 may include integrated communication capability, e.g., Wi-Fi, Bluetooth, etc. to provide the electrical power source information to one or more network elements, e.g., to the host device, NE 171, and/or others, such as server(s) 104, etc. It should again be noted that PSU 192 may be similarly configured and may thus provide electrical power source information extracted from an AC electrical power signal from PDN 194 to the host device, NE 172, and/or others, such as server(s) 104, etc.

In one example, host devices, such as NE 171, NE 172, etc. may obtain electrical power source information extracted from AC electrical power signals, and may further transmit, disseminate, and share this information with other network elements. For instance, each network element, e.g., a host device and/or a power supply module with integrated communication capability, may report electrical power source information to server(s) 104 and/or to SDN controller 106. For example, server(s) 104 may comprise a database system that may collect, store, and/or generate reports, data visualizations, or the like associated with electrical power source information for various components of the system 100, e.g., from network 102, and from access networks 120 and 122.

SDN controller 106 may also obtain and utilize electrical power source information associated with various network elements from server(s) 104 and/or from the network elements (or power supply modules) directly. For example, SDN controller 106 may be configured to instantiate VNFs on NFVI/host devices that are powered from a particular type, or types of electrical power sources. For instance, SDN controller 106 may preferentially instantiate VNFs on NFVI that meet designated electrical power source and/or energy utilization criteria, e.g., powered by wind turbine AC electrical power source(s), powered by at least x percent wind turbine AC electrical power source(s), etc. It should be noted that SDN controller 106 may implement additional criteria/rules in addition to electrical power source information. For instance, SDN controller 106 may implement a formula to rank/score NFVI as candidates for hosting one or more VNFs comprising weighted percentages or values associated with electrical power source(s), geographic location, cost, and so forth. To further illustrate, a weighted percentage or value associated with geographic location may be higher for an NFVI with a domestic electrical power source than a foreign electrical power source, or may be higher for an NFVI that is in a domestic location (e.g., a domestic data center) versus a foreign location, such that the domestic NFVI and/or NFVI with a domestic electrical power source are more likely to have a higher score and be selected compared to a non-domestic NFVI and/or an NFVI that is supplied by a non-domestic electrical power source.

Similar weightings or values may be implemented with respect to cost, type of electrical power source, etc. to provide an composite score that may be used to select a host NFVI, e.g., that with the highest score, or the like. Likewise, SDN controller 106 may obtain information that a source of AC electrical power for one or more NFVI/host devices has changed, where SDN controller 106 may be configured with rules to indicate whether and when to move a VNF to a different NFVI/host device, e.g., one that may be powered by a different type of electrical power source that is preferred over another. Alternatively, or in addition, SDN controller 106 may reconfigure one or more VNFs based upon the electrical power source information. For instance, two VNFs may provide the same service, such as a gNodeB centralized unit (CU), where one of the VNFs may be reconfigured to service additional distributed units (DUs) (e.g., an VNF hosted on NFVI with a preferred source of electrical power) and another of the VNFs may be reconfigured to service fewer distributed units (DUs) (e.g., a VNF hosted on NFVI with a less preferred source of electrical power). Similarly, a VNF may be temporarily disabled or placed into a backup mode. For instance, during certain times of peak energy demand, some power suppliers may add electrical power to the power grid from infrequently used coal or natural gas power sources. In such case, a network operator may choose to also temporarily disable VNFs (or physical network elements) that are consequently powered by such temporary power source(s).

In addition, in one example, routers may exchange electrical power source information with each other such that one router will know the sources of electric power of other routers and make routing decisions accordingly. For instance, network 102 may provide for energy utilization-aware routing of packets/flows (e.g., an energy factor-based routing). For instance, as noted above, network elements 161, 162, 171, and/or 172 may comprise routers, switches, gateways, or the like. In one example, these routing elements may be configured with routing tables and/or policies for making routing decisions for packets/flows. In one example, server(s) 104 and/or SDN controller 106 may be tasked with generating and providing initial link state databases, routing tables, or the like to network elements 161, 162, 171, and/or 172. In one example, server(s) 104 and/or SDN controller 106 may be tasked with generating and providing routing policies to network elements 161, 162, 171, and/or 172. For instance, in one example, the present disclosure may provide for a choice between [renewable energy-based routing, no preference], [energy-efficient routing, no preference], or the like. In one example, the present disclosure may provide a choice between several available tiers or categories of energy factor-based routing, such as [energy efficient, balanced, or performance]. In still another example, the present disclosure may provide a choice among different available energy sources, such as wind, nuclear, solar, natural gas, etc., may provide for the selection of sets of acceptable and/or preferred energy sources, and so on. Accordingly, server(s) 104 and/or SDN controller 106 may provision network elements 161, 162, 171, and/or 172 with corresponding policies, or rules, to effect these different preferences. In one example, network elements 161, 162, 171, and/or 172 may perform packet/flow routing in accordance with one or more routing protocols using a link state database, routing table or the like, e.g., unless superseded by one or more policies related to energy utilization-aware/energy factor-based routing (or other policy). For instance, in one example, network elements 161, 162, 171, and/or 172 may route packets/flows by default in accordance with Interior Gateway Protocol (IGP), Routing Information Protocol (RIP), Open Shortest Path First (OSPF), exterior routing protocols (e.g., Exterior Gateway Protocol (EGP), Border Gateway Protocol (BGP), etc.), or the like.

In order to provide for energy utilization-aware routing, in one example, network elements 161, 162, 171, and/or 172 may exchange energy utilization information with each other. In other words, participating network elements within a routing domain, or in multiple domains that participate in energy utilization-aware routing, may report their sources of electrical power. In addition, in one example, participating network elements may track their own energy utilizations, and may report such information to peers. For instance, each participating network element may report one or more of: a source of electrical power/energy powering the network element (e.g., natural gas, coal, nuclear, wind, solar, geothermal, hydroelectric, etc.), a data utilization per unit time and/or per data volume processed via the network element, and so forth. In one example, energy utilization information may be exchanged via an “out-of-band” control channel virtual network. For instance, a second communication mode may be used to exchange energy utilization information that is different from a first communication mode that may be used to convey user/data traffic.

In one example, the second communication mode may comprise routing protocol messages, e.g., in accordance with a routing protocol as described above, or the like. For instance, in addition to advertising routes, reachability, neighborhood topology, link costs, etc. via link state advertisements (LSAs), other link state packets, or the like, the present disclosure may extend such routing protocol messages to include energy utilization information. In another example, the second communication mode may be a different logical network from one that is used for user/data traffic. For instance, slice 1 may be used for user/data traffic, while slice 2 may comprise an overlay network/control channel virtual network for exchanging energy utilization information (and in one example, additional control information). In other words, network elements 161 and 162 may have a one-to-one correspondence on respective shared NFVI elements/nodes. For instance, NFVI 151 may host one of the network elements 161 for routing user/data traffic within slice 1, and may also host a corresponding one of the network elements 162 to participate in an energy utilization information exchange network within slice 2. In such an example, the energy utilization information may pertain to the one of the network elements 161 and/or the host NFVI 151 as a whole. Alternatively, or in addition, the second communication mode may comprise a virtual local area network (VLAN) that may be similarly established for exchanging energy utilization information.

In one example, energy utilization information may be received at a given network element in a message that includes one or more aspects of energy utilization information for one or more other network elements. For instance, the aspects of energy utilization information may include a source of electrical power/energy for a node/network element, an energy efficiency metric, e.g., an energy utilization per unit time (e.g., per minute, per hour, etc.) and/or per data volume (e.g., per packet, per MB, etc.), and so forth. In one example, the second communication mode may be used to obtain additional routing information, such as link cost, reachability, etc. For instance, slice 2 may be used to exchange routing protocol messages relating to routing that will occur in slice 1. In one example, a recipient network element (or node/NFVI and/or a corresponding network element in slice 1 for a message received in slice 2) may update a routing table and/or link state database in accordance with the information received. For instance, in one example, energy utilization information may be included in one or more additional fields in a link state database and/or routing table.

In one example, one or more of the above-mentioned routing protocols may be extended to account for one or more “energy” factors as additional “cost(s)” and/or to modify “costs” that may be calculated as per the existing protocol(s). In other words, when energy utilization-aware routing is selected, a different rule, or set of rules may be activated for calculating link/node costs, and may thus affect packet/flow routing in network 102. Alternatively, when energy utilization-aware routing is selected for a packet/flow, one or more policies/rules may be activated that supersede a default routing algorithm that may be applied to a link state database and/or derived from a routing table. In one example, energy utilization-aware routing may be selected when a flow is established. For instance, one or more initial packets may include a flag, indicator, or the like, e.g., within a packet header field, with a designated meaning of “renewable energy based routing,” “energy efficient routing,” etc. It should be noted that in one example, no flag or another flag in a designated field may indicate that default, best performance routing may be preferred. It should also be noted that the preferred routing (e.g., energy utilization-aware or not) may be selected by either endpoint of a flow. For instance, device 182 may establish communication with one of the server(s) 132 for streaming video, and either device 182 or the one of the server(s) 132 may request a specific type of routing in accordance with the present disclosure. The packets for the video stream/flow may then be received by one or more of network elements 161, 162, 171, and/or 172 and routed accordingly.

In one example, routing preferences may alternatively or additionally be established in advance of any packet(s)/flow(s) designated for a particular type of routing. For instance, a content provider operating server(s) 131 and/or 132 may designate that any flows originating or terminating at server(s) 131 and/or 132 be provided with “renewable energy-based routing.” In one example, the designation(s) may be identified by IP address(es) and/or IP range(s). In one example, such designation(s) may be further defined by source port(s) and/or destination port(s) (or any combination/sub-combination of source/destination IP address(es), sources/destination port(s), etc.), and so forth. In one example, such preferences may be communicated to server(s) 104, which may comprise a public web server or the like via which users, enterprises, etc. may request energy utilization-aware routing from network 102. As such, server(s) 104 may push policies to network elements 161, 162, 171, and/or 172 relating to designated IP addresses, IP address/port combinations, tuples, flows, etc. For instance, network elements 161, 162, 171, and/or 172 may select routes and may transmit/forward/route packets in accordance with policies that supersede a default routing algorithm, where such policies may provide for energy utilization-aware routing (or for other purposes, such as “domestic-only” routing for enhanced security, priority slice selection, such as for first responders engaging in critical communications in responding to emergencies, and so forth). In one example, server(s) 104 may be a participant in a control channel virtual network (such as slice 2) and may transmit such instructions/updates to network elements via the control channel virtual network.

In one example, an energy utilization-aware routing preference may be selected (or revoked) at any time after the commencement of a flow. For example, a video streaming service may provide for energy efficient routing for its customer streams. For instance, the video streaming service may arrange with an operator of network 102 for discount or bulk pricing for all flows to obtain energy efficient routing. However, a video server, such as one of the server(s) 131 and/or 132 may detect that a video stream for one of devices 181-184 (e.g., a flow via network 102) is experiencing delays or the like that may affect the video quality or other aspects of the user experience. As such, the server(s) 131 and/or 132 may request that energy efficient routing be temporarily suspended for the particular flow/video stream or multiple video streams for various customers via network 102. In one example, this may be accomplished by changing a flag/indicator in the packets, via message to server(s) 104, or the like.

In addition to the foregoing, FIG. 1 further illustrates that in one example, electrical power source information may be conveyed by modulating a radio signal comprising the electrical power source information around the electrical power distribution line. For instance, this may utilize radio access and backhaul nodes, where power line towers comprise convenient deployment locations for such nodes. In particular, these nodes may provide broadband access and backhaul to endpoint devices in essentially parallel paths with the electrical power distribution lines. Accordingly, a network of such nodes may conveniently convey electrical power information about the AC electrical power signals traversing the same paths. Thus, for example, radio access and backhaul (RAB) node 188 may obtain electrical power source information over PDN 193, e.g., where modulator 189 may also comprise an RAB node in such an example. In addition, the RAB node 188 may broadcast this electrical power source information to endpoint devices in a communication range of the RAB node 188. As such, network elements, such as NFVI 151, NE 171, NE 172, etc. may also be configured to receive the electrical power source information from RAB node 188, or the like. For instance, RAB node 188 may include electrical power source information in a system information block (SIB) or the like, depending upon the particular wireless communication protocol(s) employed in connection with RAB nodes, such as RAB node 188. In one example, these RAB nodes may utilize inductive coupling around power lines to power themselves, and which may comprise an array of horn antennas, plastic antennas, or the like using the power lines as guides for the radio signals between RAB nodes. It should be noted that while only two RAB nodes are illustrated in FIG. 1 (e.g., RAB node 188 and modulator 189), in various examples, there may be one or more additional nodes between the source that initially transmits the electrical power source information and the RAB node 188 that communicates the electrical power source information to network elements or other endpoints. These and other aspects of the present disclosure are further described below in connection with the example method 200 of FIG. 2 and/or the example method 300 of FIG. 3.

In addition, it should be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as additional border elements, routers, switches, policy servers, security devices, gateways, a content distribution network (CDN), and the like. Similarly, although only two access networks 120 and 122 are shown, in other examples, access networks 120 and/or 122 may each comprise a plurality of different access networks that may interface with network 102 independently or in a chained manner. For example, devices 181 and 182, and server(s) 131, respectively, may be in communication with network 102 via different access networks, and devices 183 and 184, and server(s) 132, may be in communication with network 102 via two or more different access networks, and so forth. It should also be noted that in one example, energy utilization-aware/energy factor-based routing may also extend to one or more of access network(s) 120 and 122. Thus, these and other modifications are all contemplated within the scope of the present disclosure.

FIG. 2 illustrates a flowchart of an example method 200 for extracting electrical power source information from an alternating current electrical power signal and providing the electrical power source information to at least one communication network element. In one example, the method 200 is performed by a network-based component of the system 100 of FIG. 1, such as by a power supply unit 191 or 192, one of network elements 161, 162, 171, or 172, and/or any one or more components thereof (e.g., PSU 191 or PSU 192, a processor, or processors, performing operations stored in and loaded from a memory), by a network element in conjunction with one or more other devices, such as one or more other network elements, server(s) 104 and/or SDN controller 106, endpoint devices, and so forth. In one example, the steps, functions, or operations of method 200 may be performed by a computing device or system 400, and/or processor 402 as described in connection with FIG. 4 below. For instance, the computing device or system 400 may represent any one or more components of FIG. 1 or the like that is/are configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 400 may collectively function as a processing system. For illustrative purposes, the method 200 is described in greater detail below in connection with an example performed by a processing system. The method 200 begins in step 205 and proceeds to step 210.

At step 210, the processing system, e.g., deployed in a communication network, obtains an AC electrical power signal via an electrical power distribution line, where the AC electrical power signal is modulated to include electrical power source information for a source of electrical power. For instance, in one example, the processing system may comprise a power supply module for converting the AC electrical power signal into a DC signal for powering at least one component of the communication network. In addition, in one example, the AC electrical power signal may be modulated to include electrical power source information using a power line carrier communication (e.g., PLC/PLCC).

At step 220, the processing system extracts the electrical power source information from the AC electrical power signal. For instance, as described above, the processing system may comprise a power supply module. In addition, in accordance with the present disclosure, such a power supply module may include a demodulator (or modem) to extract the electrical power source information from the AC electrical power signal. The electrical power source information may identify at least one of: a source of the AC electrical power signal or a type of a source of the AC electrical power signal (e.g., solar, wind, hydroelectric, geothermal, coal, natural gas, nuclear, etc.). As described above, electrical power source information may include optional information, such as cost, geographic location of the source, etc. Alternatively, or in addition, in one example, the electrical power source information may include percentages of electrical power from a plurality of sources to an electrical power distribution network.

At step 230, the processing system provides the electrical power source information to at least one element of the communication network to perform at least one control action in the communication network in response to the electrical power source information. For instance, in one example, the at least one control action may include instantiating a VNF, de-instantiating a VNF, configuring a VNF, and so forth. In one example, the at least one control action may alternatively or additionally include a routing action, e.g., a routing decision, a routing instruction to one or more other network elements, etc. In one example, the routing action may include the processing system itself implementing the routing (e.g., where the processing system is itself a network element, and more specifically, a router), or via instruction(s) to one or more other network elements (e.g., one or more routers, etc.).

In still another example, a control action may include reporting of the electrical power source information for the at least one element to at least one other device. For instance, in one example, the at least one element may be a management system. However, in another example, the at least one element may be a network element comprising the power supply including the demodulator, or that otherwise obtains DC electrical power from the power supply, which may report to another entity regarding its source of electrical power (e.g., electrical power source information). For instance, the network element may be a router reporting the electrical power source information to one or more other routers. Alternatively, or in addition, the network element may be a router reporting the electrical power source information to one or more endpoint devices, which can then choose “green energy routing,” “renewable energy-based routing,” etc. In still another example, the processing system may comprise the power supply including the demodulator, which may communicate with its host device, where the host device can be the at least one element, or where the host device is a different device that may then communicate to the at least one element, e.g., via Ethernet, Wi-Fi, USB, or other local communications with the at least one element. Accordingly, in one example, the processing system (e.g., a power supply) may provide the electrical power source information to at least one element of the communication network via at least one of: an inter-integrated circuit (I2C) communication, a system management bus communication, a serial peripheral interface (SPI) communication, a controller area network communication, or the like.

Following step 230, the method 200 proceeds to step 295 where the method ends.

It should be noted that the method 200 may be expanded to include additional steps, or may be modified to replace steps with different steps, to combine steps, to omit steps, to perform steps in a different order, and so forth. For instance, in one example, the processing system may repeat steps 210-230 on an ongoing basis to continue to obtain and report electrical power source information, or to obtain changes or updates to the electrical power source information, where different control actions may be applied in response to such changes/updates, and so on. In one example, the method 200 may be modified such that a radio signal comprising the electrical power source information transmitted around the electrical power distribution line may be received at step 210. For instance, the processing system may comprise a radio access and backhaul node, which may be deployed on a structure supporting the electrical power distribution line, e.g., a power line tower or the like. In one example, the method 200 may be expanded or modified to include steps, functions, and/or operations, or other features described above in connection with the example(s) of FIG. 1, FIG. 3, or as described elsewhere herein. Thus, these and other modifications are all contemplated within the scope of the present disclosure.

FIG. 3 illustrates a flowchart of an example method 300 for selecting at least one control action for a communication network in response to electrical power source information obtained via an alternating current electrical power distribution line. In one example, the method 300 is performed by a network-based component of the system 100 of FIG. 1, such as by one of server(s) 104 or SDN controller 106, network elements 161, 162, 171, or 172, and/or any one or more components thereof (e.g., PSU 191 or PSU 192, a processor, or processors, performing operations stored in and loaded from a memory), by a network element in conjunction with one or more other devices, such as one or more other network elements, endpoint devices, and so forth. In one example, the steps, functions, or operations of method 300 may be performed by a computing device or system 400, and/or processor 402 as described in connection with FIG. 4 below. For instance, the computing device or system 400 may represent any one or more components of FIG. 1 or the like that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system. The method 300 begins in step 305 and proceeds to step 310.

At step 310, the processing system obtains electrical power source information for a source of electrical power to at least one network element of a communication network, where the electrical power source information is obtained via an AC electrical power distribution line. For instance, in one example, an AC electrical power signal on the AC electrical power distribution line is modulated to include electrical power source information using a power line carrier communication (PLC/PLCC). The electrical power source information may identify at least one of: a source of the AC electrical power signal or a type of a source of the AC electrical power signal (e.g., solar, wind, hydroelectric, geothermal, coal, natural gas, nuclear, etc.). As described above, electrical power source information may include optional information, such as cost, geographic location of the source, etc. Alternatively, or in addition, in one example, the electrical power source information may include percentages of electrical power from a plurality of sources to an electrical power distribution network.

In various examples, the processing system may comprise a software-defined network controller, a self-organizing network orchestrator, a router, an endpoint device, and so forth. For instance, a router may receive the electrical power source information from another router. An SDN controller may receive the electrical power source information from a router or other network elements, which may comprise a VNF, an NFVI/host device, or other physical network elements. Alternatively, or in addition, the processing system may obtain the electrical power source information from a network repository, e.g., a centralized or distributed database system that may previously obtain and store the electrical power source information.

In one example, the processing system may include a power supply module for converting the AC electrical power signal into a DC signal for powering at least one component of the communication network. For instance, the power supply module may include a demodulator (or modem) to extract the electrical power source information from the AC electrical power signal. In addition, in such an example, the electrical power source information may be obtained via at least one of: an inter-integrated circuit (I2C) communication, a system management bus communication, a serial peripheral interface (SPI) communication, a controller area network communication, or the like.

At optional step 320, the processing system may provide the electrical power source information to at least one device that is external to the communication network. For instance, the processing system may comprise an edge router (e.g., a provider edge (PE) router) that may provide the electrical power source information to a customer edge (CE) router, or may comprise a CE router than participates in exchange of electrical power source information, and which may provide the electrical power source information of one or more routers within the communication network to an endpoint device.

At optional step 330, the processing system may obtain a selection of at least one control action from the at least one device that is external to the communication network. For instance, an endpoint device and/or a CE router may select clean-energy routing, may select solar energy routing, etc. In one example, the endpoint device and/or CE router may select a particular routing path based upon the electrical power source information of the at least one network element (and in one example, further based upon electrical power source information of one or more other network elements). In one example, the selection may be contained in a header options field of at least one packet to be routed, e.g., a Transmission Control Protocol (TCP) options field, an IP options field, or the like. In another example, an endpoint device may select for instantiating of a VNF serving the endpoint device or a customer associated with the endpoint device on NFVI associated with a particular power source, e.g., based upon the electrical power source information.

At step 340, the processing system selects at least one control action for the communication network in response to the electrical power source information. For example, the control action may be selected in accordance with a rule set or via a machine learning model-based control action selection algorithm implemented by the processing system. For instance, control action can be defined by rules/triggers and/or can be learned over time based upon past manual selections. For example, user/endpoint device selections of “clean-energy routing” or not can be used as labels to decide default routing for future instances of communication sessions. In addition, in one example, default routing can be overridden by users/endpoint devices, which in turn may be used as additional labeled data for model training/retraining, and so forth. The at least one control action may include instantiating a VNF, de-instantiating a VNF configuring a VNF, and so forth. In one example, the at least one control action may alternatively or additionally include a routing action, e.g., a policy-based routing comprising a routing decision, a routing instruction to one or more other network elements, etc. In one example, the at least one control action may be selected in response to selection obtained from the at least one device external to the communication network at optional step 330.

In one example, the processing system may apply a policy-based routing in accordance with electrical power source information of a plurality of network elements of the communication network. In one example, the routing may be based upon electrical power source information of the plurality of network elements and at least one of: link costs for links between the plurality of network elements, network delay of at least one of the plurality of network elements or the links between the plurality of network elements, or a number of hops between network elements from a source to a destination within the communication network. Alternatively, or in addition, the routing may be in accordance with link costs, where the link costs (e.g., based on throughput/capacity, or other factor(s)) may be modified based upon one or more energy factor(s). For instance, cost-based routing such as Open Shortest Path First (OSPF), Enhanced Interior Gateway Routing Protocol (EIGRP), or the like may be extended to account for one or more “energy” factors as additional cost(s). For instance, if a “renewable energy source routing preferred” option is selected, the cost of routing via a non-renewable energy source powered network element may be increased, even if the network element and or the link thereto has a high throughput, short distance, and so forth. In another example, a cost may be reduced when a network element is renewable energy powered. In one example, a scaling factor may be applied based on the electrical power/energy source, e.g., the type thereof. Similarly, in one example where the selection indicates that energy efficient routing is preferred, a cost of a network element may be scaled to be lower when the network element is energy efficient compared to peers, and conversely may be increased when the network element is energy inefficient compared to peers. In one example, scaling factors for different electrical power/energy sources or types of electrical power/energy sources may be set by a network operator. In one example, a scaling factor may be applied to a cost calculation for a network element, where the scaling factor may be proportional to the energy utilization metric for a network element (e.g., energy utilization per unit time and/or per data volume). It should be noted that examples of the present disclosure are not limited to any particular routing protocol and may relate to other interior routing protocols (e.g., Routing Information Protocol (RIP)), exterior routing protocols (e.g., Exterior Gateway Protocol (EGP), Border Gateway Protocol (BGP), or the like), and so forth.

At step 350, the processing system performs the at least one control action in the communication network. As discussed above, the at least one control action may include instantiating a VNF, de-instantiating a VNF configuring a VNF, and so forth. For instance, the processing system may comprise an SDN controller, SON orchestrator, or the like, which may transmit one or more instructions to one or more host devices to instantiate or de-instantiate a VNF. Similarly, the processing system comprising an SDN controller, SON orchestrator, or the like may alternatively or additional transmit one or more instructions to one or more VNFs to configure/reconfigure. For instance, a VNF may be temporarily disabled or placed into a backup mode, and so forth. In one example, the at least one control action may alternatively or additionally include a routing action. In one example, the routing action may include the processing system itself routing packets or other protocol data units (e.g., where the processing system is itself a network element, and more specifically, a router), or via instruction(s) to one or more other network elements (e.g., one or more routers, etc.).

Following step 350, the method 300 proceeds to step 395 where the method ends.

It should be noted that the method 300 may be expanded to include additional steps, or may be modified to replace steps with different steps, to combine steps, to omit steps, to perform steps in a different order, and so forth. For instance, in one example, the processing system may repeat steps 310-350 on an ongoing basis to continue to obtain electrical power source information, or to obtain changes or updates to the electrical power source information, where different control actions may be applied in response to such changes/updates, and so on. In one example, the method 300 may be expanded or modified to include steps, functions, and/or operations, or other features described above in connection with the example(s) of FIG. 1, FIG. 2, or as described elsewhere herein. Thus, these and other modifications are all contemplated within the scope of the present disclosure.

In addition, although not expressly specified above, one or more steps of the method 200 or the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above-described method(s) can be combined, separated, and/or performed in a different order from that described above, without departing from the example embodiments of the present disclosure.

FIG. 4 depicts a high-level block diagram of a computing device or processing system specifically programmed to perform the functions described herein. For example, any one or more components or devices illustrated in FIG. 1 or described in connection with the example(s) of FIG. 2 and/or FIG. 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for extracting electrical power source information from an alternating current electrical power signal and providing the electrical power source information to at least one communication network element and/or for selecting at least one control action for a communication network in response to electrical power source information obtained via an alternating current electrical power distribution line, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above-disclosed method(s). In one example, instructions and data for the present module or process 405 for extracting electrical power source information from an alternating current electrical power signal and providing the electrical power source information to at least one communication network element and/or for selecting at least one control action for a communication network in response to electrical power source information obtained via an alternating current electrical power distribution line (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above-described method(s) can be perceived as a programmed processor or a specialized processor. As such, the present module 405 for extracting electrical power source information from an alternating current electrical power signal and providing the electrical power source information to at least one communication network element and/or for selecting at least one control action for a communication network in response to electrical power source information obtained via an alternating current electrical power distribution line (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor deployed in a communication network, an alternating current electrical power signal via an electrical power distribution line, wherein the alternating current electrical power signal is modulated to include electrical power source information for a source of electrical power;
extracting, by the processing system, the electrical power source information from the alternating current electrical power signal; and
providing, by the processing system, the electrical power source information to at least one element of the communication network to perform at least one control action in the communication network in response to the electrical power source information.

2. The method of claim 1, wherein the processing system comprises a power supply module for converting the alternating current electrical power signal into a direct current signal for powering at least one component of the communication network.

3. The method of claim 2, wherein the power supply module includes a demodulator to extract the electrical power source information from the alternating current electrical power signal.

4. The method of claim 2, wherein the power supply provides the electrical power source information to at least one element of the communication network via at least one of:
an inter-integrated circuit communication;
a system management bus communication;
a serial peripheral interface communication; or
a controller area network communication.

5. The method of claim 1, wherein the alternating current electrical power signal is modulated to include the electrical power source information using a power line carrier communication.

6. The method of claim 1, wherein the electrical power source information identifies:
a source of the alternating current electrical power signal; or
a type of a source of the alternating current electrical power signal.

7. The method of claim 1, wherein the at least one control action comprises at least one of:
instantiating a virtual network function;
de-instantiating a virtual network function; or
configuring a virtual network function.

8. The method of claim 1, wherein the at least one control action comprises a routing action.

9. The method of claim 1, wherein the at least one control action comprises a reporting of the electrical power source information for the at least one element to at least one other device.

10. A non-transitory computer-readable medium storing instructions which, when executed by a processing system including at least one processor when deployed in a communication network, cause the processing system to perform operations, the operations comprising:
obtaining an alternating current electrical power signal via an electrical power distribution line, wherein the alternating current electrical power signal is modulated to include electrical power source information for a source of electrical power;
extracting the electrical power source information from the alternating current electrical power signal; and
providing the electrical power source information to at least one element of the communication network to perform at least one control action in the communication network in response to the electrical power source information.

11. A method comprising:
obtaining, by a processing system including at least one processor, electrical power source information for a source of electrical power to at least one network element of a communication network, wherein the electrical power source information is obtained via an alternating current electrical power distribution line;
selecting, by the processing system, at least one control action for the communication network in response to the electrical power source information; and
performing, by the processing system, the at least one control action in the communication network.

12. The method of claim 11, wherein the at least one control action comprises at least one of:
instantiating a virtual network function;
de-instantiating a virtual network function; or
configuring a virtual network function.

13. The method of claim 12, wherein the processing system comprises:
a software-defined network controller; or
a self-organizing network orchestrator.

14. The method of claim 11, wherein the at least one control action comprises a routing action.

15. The method of claim 14, wherein the processing system comprises:
a router; or
an endpoint device.

16. The method of claim 11, wherein the at least one control action is selected in accordance with a rule set or via a machine learning model-based control action selection algorithm implemented by the processing system.

17. The method of claim 11, further comprising:
providing the electrical power source information to at least one device that is external to the communication network.

18. The method of claim 17, further comprising:
obtaining a selection of the at least one control action from the at least one device that is external to the communication network.

19. The method of claim 11, wherein an alternating current electrical power signal on the alternating current electrical power distribution line is modulated to include electrical power source information using a power line carrier communication.

20. The method of claim 19, wherein the electrical power source information identifies:
a source of the alternating current electrical power signal; or
a type of a source of the alternating current electrical power signal.
